(19) United States
(12) Patent Application Publication
(10) Pub. No.: US 2026/0057909 A1
(43) Pub. Date: Feb. 26, 2026

(54) SYSTEM AND METHOD TO GENERATING VIDEO BY USING CLASSES

(71) Applicant: Idomoo LTD, Raanana (IL)

(72) Inventor: Danny KALISH, Raanana (IL)

(21) Appl. No.: 19/305,276

(22) Filed: Aug. 20, 2025

Related U.S. Application Data
(60) Provisional application No. 63/685,124, filed on Aug. 20, 2024.

(51) Int. Cl. G11B 27/031; G06Q 30/0241; G06V 10/764; G06V 20/40; G11B 27/34

(52) U.S. Cl. CPC G11B 27/031; G06Q 30/0276; G06V 10/764; G06V 20/41; G11B 27/34

(57) ABSTRACT

The present invention disclose method for generating variant video using an AI model, comprising the steps of:
Receiving new classes of video format/block defined by functionality including instruction of video block usage/implementation rules: context required data types; scenarios;
Applying designated AI module to parse instruction learn the rules to applied on received instruction to generate video block;
apply the class instructions by using designated AI model to implement new class and create variant video.

### BACKGROUND

### Technical Field

The present invention relates generally to automated video generation systems, and more particularly to an artificial intelligence-driven platform for generating customized videos using, class-based video definitions, and intelligent multimedia content aggregation

The field of automated video generation faces significant challenges that limit the effectiveness and accessibility of current solutions. Traditional video production is labor-intensive, expensive, and requires specialized expertise, making it unsuitable for scalable content creation needs. While automated video generation platforms have emerged to address these limitations, existing solutions suffer from critical deficiencies.

Current template-based video platforms provide rigid structures with limited flexibility, producing generic output that fails to capture specific brand identities or contextual requirements. Users must manually select templates and customize elements, requiring design knowledge and significant time investment. AI-powered content generation systems struggle with context understanding, content integration, and quality consistency, often treating different media types as separate elements rather than creating cohesive experiences.

Technical architecture limitations further constrain existing platforms through monolithic system designs that limit scalability, narrow AI applications focused on isolated tasks rather than comprehensive integration, and inadequate metadata management systems that cannot effectively track complex content relationships or support efficient discovery.

These limitations create a demonstrated need for an improved video generation system that can provide intelligent template selection, sophisticated content integration, advanced personalization capabilities, scalable AI-driven architecture, intelligent content aggregation, and comprehensive metadata management. The present invention addresses these technological gaps by combining advanced artificial intelligence with innovative template-based architectures and class-based content organization to enable efficient, scalable, and high-quality automated video production

### SUMMARY

The present invention disclose method for generating variant video using an AI model, comprising the steps of:
Receiving new classes of video format/block defined by functionality including instruction of video block usage/implementation rules: context required data types; scenarios;
Applying designated AI module to parse instruction learn the rules to applied on received instruction to generate video block: checking the new class relevancy
If relevant apply the class instructions by using designated AI model to implement new class and create video format/block as part of the

The present invention disclose a computer-implemented method for generating variant video using an AI model, implemented by one or more processors operatively coupled to a non-transitory computer readable storage device, on which are stored modules of instruction code that when executed cause the one or more
processors to perform said method comprising the steps of:
   performing predefined class definition analysis by:
analyzing style characteristics to identify visual and structural patterns unique to each predefined class;
classifying data fields according to their properties and types;
determining required input and output formats and data structures for each class;
   performing functional context analysis predefined class, using an AI model by:
parsing and interpreting functional requirements and specifications;
analyzing object relationships and associated data dependencies;
   generating a customized AI model that synthesizes the class definition analysis and functional context analysis; and
   producing specialized video content using the customized AI model based on the predefined class definitions.

According to some embodiments of the present invention the customized AI model employs tag-based learning by extracting knowledge from class tags and object classifications.

According to some embodiments of the present invention the customized AI model employs structural learning by understanding relationships between class objects and their hierarchical organization.

According to some embodiments of the present invention the customized AI model employs example-driven learning incorporating specific examples selected from the group consisting of:
class implementations;
object instances;
attribute configurations; and
behavioral patterns.

According to some embodiments of the present invention the analyzing style characteristics comprises identifying visual patterns and structural patterns that distinguish each class from other classes in the system.

According to some embodiments of the present invention detecting issues within class definitions comprises identifying potential problems, constraints, or limitations that may affect class implementation or performance.

According to some embodiments of the present invention identifying parsing and interpreting functional requirements and specifications comprises recognizing functional blocks and determining their interdependencies within the system architecture.

The present invention discloses a system for generating customized video content using artificial intelligence, comprising:
a processor; and
a memory storing instructions that, when executed by the processor, cause the system to:
   perform class definition analysis including style analysis, issue identification, field classification, and format specification determination;
   perform functional context analysis using an AI model to comprehend instructions, identify functional blocks, map scenarios, analyze object relationships, and assess data relevance;
   generate a customized AI model that synthesizes results from the class definition analysis and functional context analysis; and
   produce specialized video content using the customized AI model based on predefined class definitions.

According to some embodiments of the present invention the instructions further cause the system to implement multiple learning mechanisms including tag-based learning, structural learning, and example-driven learning.

According to some embodiments of the present invention the functional context analysis comprises scenario mapping to understand various use cases and operational contexts for video content generation.

According to some embodiments of the present invention the class definition analysis and functional context analysis are performed iteratively to refine the customized AI model based on feedback from video content generation results.

The present invention disclose a computer-implemented method for generating variant video using an AI model, implemented by one or more processors operatively coupled to a non-transitory computer readable storage device, on which are stored modules of instruction code that when executed cause the one or more processors to perform said method comprising the steps of:
perform intelligent class selection by utilizing artificial intelligence model to select relevant classes for a given task from a plurality of predefined classes, wherein the task comprises at least one of product promotion and script support;
perform class combination and adaptation by strategically selecting classes for each segment of a script, analyzing styles of the selected classes, and grouping compatible classes with adjusted formats and technical properties for optimal performance;
aggregate multimedia content from diverse sources comprising text, images, and videos, wherein the content is selected based on relevance to requirements of the selected classes;
create scenes using the aggregated content aligned with the selected classes, including generation of new original content when necessary;
produce audio components comprising voiceover generation using text-to-speech technology with selectable narrator tones and complementary background music;
generate text for video placeholders ensuring consistency with class requirements and overall video style; and
customize all scene media components to align with entity branding by incorporating branding and profile data obtained through at least one of direct user input and automated analysis of entity content.

According to some embodiments of the present invention the instructions further cause the system to:
implement performance analytics by establishing tracking mechanisms to assess impact of applied classes;
collect data on viewer engagement and response; and
perform iterative improvement of class selection and application based on performance metrics.

According to some embodiments of the present invention the intelligent class selection comprises:
analyzing task requirements to determine effectiveness and compatibility metrics for available classes;
ranking classes based on relevance to project goals; and
selecting an optimal combination of classes that maximizes task performance while maintaining technical compatibility.

According to some embodiments of the present invention the customization of scene media components comprises:
analyzing entity branding elements including logos, color schemes, and typography;
extracting branding data from entity websites and press materials using automated content analysis; and
applying the extracted branding elements consistently across all generated video components.

According to some embodiments of the present invention:
modifying the content script based on the selected classes; and
generating directing instructions derived from customized brand classes, wherein the classes include embedded instructions for content creation.

According to some embodiments of the present invention the operations further comprise:
performing advanced scene creation by developing scenes using both aggregated content and newly generated original content when existing content is insufficient for class requirements.

According to some embodiments of the present invention the audio production comprises:
analyzing contextual requirements of the video content to determine appropriate emotional expression;
selecting narrator tones from a plurality of available tones including friendly, excited, and cheerful tones;
tailoring emotional expression specifically for advertisement contexts; and
matching background music to enhance overall impact of the generated video content.

### BRIEF DESCRIPTION OF THE SCHEMATICS

The present invention will be more readily understood from the detailed description of embodiments thereof made in conjunction with the accompanying drawings of which:

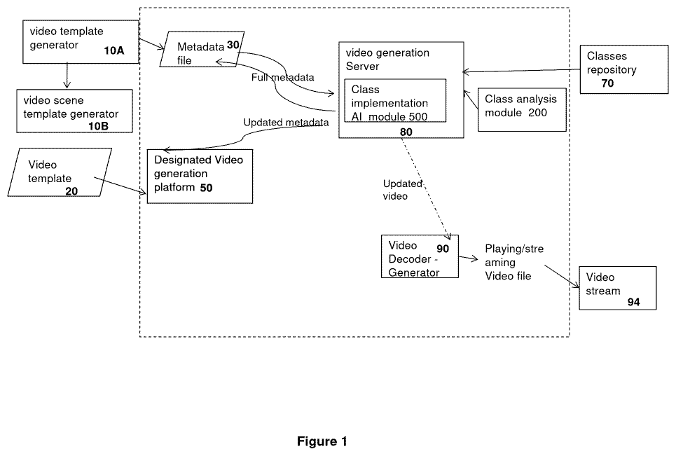

FIG. 1 is a block diagram, depicting the components and the environment of the video generation platform, according to some embodiments of the invention.

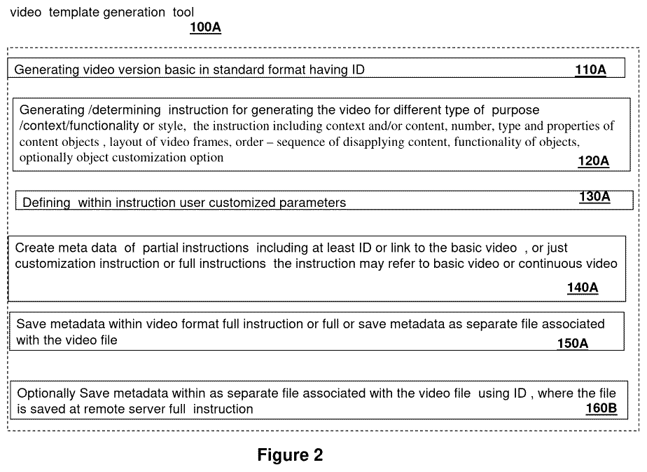

FIG. 2 is a flowchart depicting the video template generation module, according to some embodiments of the invention.

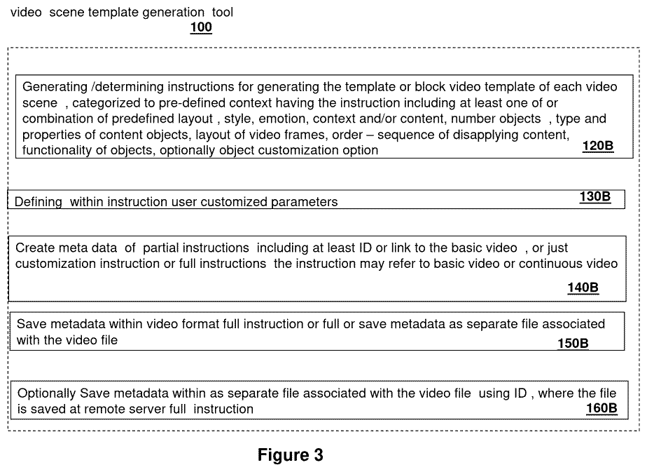

FIG. 3 is a flowchart depicting the video scene template generation tool, according to some embodiments of the invention.

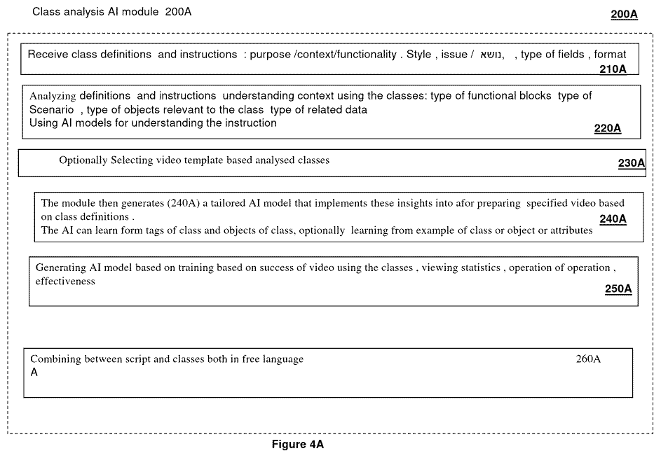

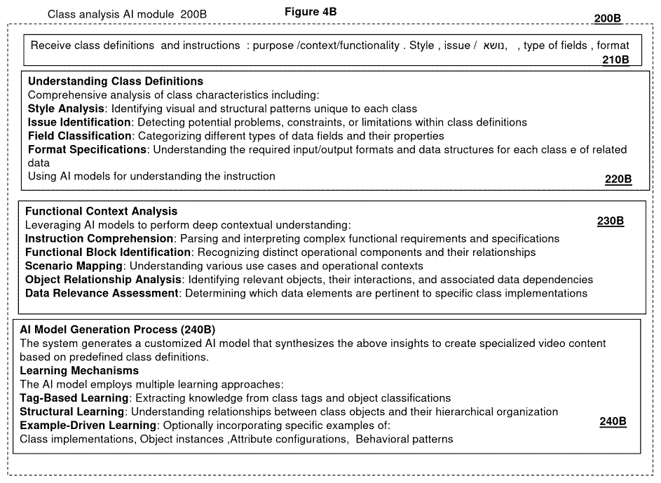

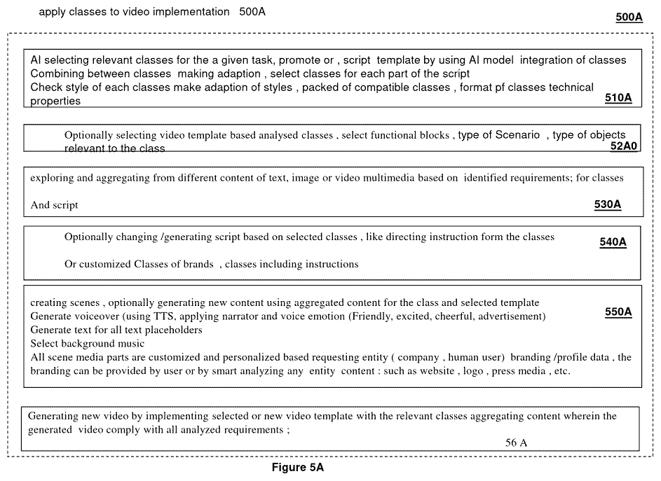

FIG. 4A is a flowchart depicting the classes analysis module 300, according to some embodiments of the invention.

FIG. 4B is a flowchart depicting the classes analysis module 400, according to some embodiments of the invention

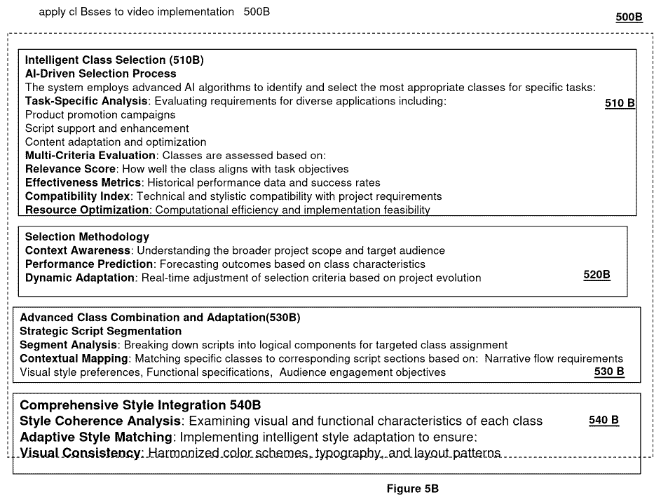

FIG. 5A is a flowchart depicting applying of Classes to Video Requirement or template 500, according to some embodiments of the invention;

FIG. 5B is a flowchart depicting applying of Classes to Video Requirement o, according to some embodiments of the invention

### DETAILED DESCRIPTION OF THE VARIOUS MODULES

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 1 is a block diagram, depicting the components and the environment of the video generation platform, according to some embodiments of the invention.
schematic representation of a video generation system. Here is a detailed description and explanation of the components and their interactions:
   Video Template Generator (10A): This module generates basic video templates, which are the foundational structures for creating videos.
   Video Scene Template Generator (10B): This module generates scene-specific templates, which add detailed structures and elements to the basic video templates.
   Video Template (20): The output from the Video Template Generator and the Video Scene Template Generator, which serves as the blueprint for the video.
   Metadata File (30): This file contains metadata, which includes information about the video template, such as the structure, content, and other relevant data.
   Designated Video Generation Platform (50): This platform uses the video template and metadata to generate videos. It likely incorporates both the structural and content information provided by the templates and metadata.
   Class Analysis AI Module (300): This module performs an analysis of the classes, which could refer to content classification, scene classification, or any other categorization necessary for video generation.
   Class Implementation AI Module (700): This module is responsible for implementing the classes identified by the Class Analysis AI Module into the video generation process.
   Video Generation Server (80): This server coordinates the video generation process, utilizing the Class Implementation AI Module and integrating metadata and template information.
   Classes repository (70): source for incoming new classes.
   Video Decoder-Generator, decoding new generated video, creating video stream 94.

FIG. 2 is a flowchart depicting the video template generation module, according to some embodiments of the invention.

The Video Template Generation Module is a sophisticated component designed for creating and managing video templates. It incorporates a series of steps, each contributing to the generation and customization of video templates.

Basic Video Generation (110A): The module begins by generating a basic version of the video in a standard format. Each basic video is assigned a unique identification number (ID), facilitating easy tracking and reference, 110A;
Generating/determining instruction for generating the basic video and/or continuous video, each video categorized to pre-defined context.
Instruction Generation/Determination (120): In this step, the module generates or determines instructions for creating both the basic video and any continuous videos. Each video is categorized into predefined contexts, ensuring relevance and appropriateness. These instructions encompass various aspects, such as predefined layouts, styles, emotional tones, contexts and content, the number of objects, types and properties of content objects, layouts of video frames, sequences of content display, object functionalities, and options for object customization; 120.
Defining within instruction scripts customized to defined scenarios related to the predefined context.

Script Definition for Scenarios (130A): Within these instructions, the module defines scripts that are customized to specific scenarios related to the predefined context. This step ensures that the video content is not only technically sound but also contextually relevant and engaging 130A;

Customized Parameter Definition: The module allows for the definition of user-customized parameters within the instructions. This customization ensures that the final video product aligns closely with the user's specific requirements and preferences.

Metadata Creation (140A): The module creates metadata for partial instructions, which includes at least the ID or a link to the basic video. It may also include customization instructions or full instructions. This metadata serves as a reference point, linking the instructions to either the basic or continuous videos 140A;

Metadata Storage (150A): The generated metadata is either saved within the full instruction set of the video format or stored as a separate file associated with the video file. This organization ensures easy retrieval and management of the metadata 150A;

Remote Storage Option (160A): Optionally, the metadata can be stored as a separate file on a remote server, associated with the video file using its ID. This option provides additional flexibility and security for storing and accessing video-related data 160A.

FIG. 3 is a flowchart depicting the video scene template generation tool, according to some embodiments of the invention.

The video template generation module applies at least one of the followings steps:
Generating/determining instruction for generating the video scene, each video scene categorized to pre-defined context having predefined layout which relate to layout of the website type
style, context and/or content, number, type and properties of content objects, layout of video frames, order-sequence of disapplying content, functionality of objects, optionally object customization option, 120B.

Defining within instruction user customized parameters 130B;

Create meta data of partial instructions including at least ID or link to the basic video, or just customization instruction or full instructions the instruction may refer to basic video or continuous video 140B;

Save metadata within video format full instruction or full or save metadata as separate file associated with the video file 150B;

Optionally Save metadata within as separate file associated with the video file using ID, where the file is saved at remote server full instruction 160B.

1. Receive Class Definitions and Instructions:
Purpose/Context/Functionality
Style
Issues to address
Type of fields
Format requirements

2. Analyze Definitions and Instructions:
Understand context using class information: a. Types of functional blocks b. Types of scenarios c. Types of objects relevant to the class d. Types of related data
Utilize AI models for comprehensive instruction understanding

3. Select Video Template:
Based on analyzed classes and their requirements

4. Generate AI Model:
Create a specialized AI model for implementing the video class based on the analysis

5. Apply Classes to Video Requirements:
AI selects relevant classes for the given task, promotion, or script template
Integrate classes using the AI model
Combine and adapt classes as needed

6. Optional Template Refinement:
Further select or refine video templates based on: a. Functional blocks b. Types of scenarios c. Objects relevant to the class

7. Content Exploration and Aggregation:
Search and aggregate content from various multimedia sources (text, image, video) based on identified class requirements

8. Scene Creation:
Generate new content using aggregated materials for the class and selected template
Create scenes incorporating the generated content

9. Audio Elements:
Generate voiceover using Text-to-Speech (TTS) technology
Apply appropriate narrator voice and emotion (e.g., friendly, excited, cheerful, advertisement-style)
Select suitable background music

10. Text Generation:
Create text for all placeholders in the video

11. Customization and Personalization:
Tailor all scene media parts based on the requesting entity (company or human user)
Incorporate branding/profile data, which can be: a. Provided directly by the user b. Smart-analyzed from entity content (website, logo, press media, etc.)

FIG. 4A is a flowchart depicting the classes analysis module 400, according to some embodiments of the invention

The Class Analysis AI Module 300 is designed to receive and interpret class definitions along with accompanying instructions, outlining their purpose, context, and functionality. The analysis involves:

1. Receive Class Definitions and Instructions: (210A)
Purpose/Context/Functionality
Style
Issues to address
Type of fields
Format requirements
tags
Understanding Class Definitions: Grasping the style, issues, types of fields, and formats specific to each class. 220A
Analyzing Functional Context: Using AI models to comprehend the instructions, identifying the type of functional blocks, scenarios, relevant objects, and related data pertinent to each class. 230A
Optionally Template Selection: Based on the analysis, the module selects appropriate video templates that align with the identified class characteristics. 230

The module then generates (240A) a tailored AI model that implements these insights for preparing specified video based on class definitions.

The AI can learn form tags of class and objects of class, optionally learning from example of class or object or attributes

According to some embodiments of the present invention it is suggested to integrate between given script and classes both may be written in free language 260A;

The script may be divided to parts, to adapt to class time duration

If the class is longer than the class, you can make the class shorter, cutting classes in point the designer pre-defined, AI decide how to cut based on designing rules or based on designer choice.

FIG. 4B is a flowchart depicting the classes analysis module 400, according to some embodiments of the invention

### Understanding Class Definitions (220B)

Comprehensive analysis of class characteristics including:
Style Analysis: Identifying visual and structural patterns unique to each class
Issue Identification: Detecting potential problems, constraints, or limitations within class definitions
Field Classification: Categorizing different types of data fields and their properties
Format Specifications: Understanding the required input/output formats and data structures for each class

### Functional Context Analysis (230B)

Leveraging AI models to perform deep contextual understanding:
Instruction Comprehension: Parsing and interpreting complex functional requirements and specifications
Functional Block Identification: Recognizing distinct operational components and their relationships
Scenario Mapping: Understanding various use cases and operational contexts
Object Relationship Analysis: Identifying relevant objects, their interactions, and associated data dependencies
Data Relevance Assessment: Determining which data elements are pertinent to specific class implementations

### AI Model Generation Process (240B)

The system generates a customized AI model that synthesizes the above insights to create specialized video content based on predefined class definitions.

### Learning Mechanisms

The AI model employs multiple learning approaches:
Tag-Based Learning: Extracting knowledge from class tags and object classifications
Structural Learning: Understanding relationships between class objects and their hierarchical organization
Example-Driven Learning: Optionally incorporating specific examples of:
   Class implementations
   Object instances
   Attribute configurations
   Behavioral patterns

FIG. 5A is a flowchart depicting applying of Classes to Video Requirement or template 500, according to some embodiments of the invention

This process encompasses several sophisticated steps:
Classes Selection: AI selects relevant classes for a given task, whether to promote a product, support a script,
   Combining between classes making adaption, select classes for each part of the script

Check style of each classes make adaption of styles, packed of compatible classes, format pf classes technical properties
Template and Content Integration: Optionally, the module can choose video templates based on the analyzed classes, select functional blocks, types of scenarios, and objects relevant to the class;

1. Intelligent Class Selection: 510A
AI-driven selection of relevant classes for the given task
Tasks may include product promotion, script support, or template integration
Classes are chosen based on their relevance, effectiveness, and compatibility with the project goals

2. Class Combination and Adaptation:
Strategic selection of classes for each script segment
Style analysis and adaptation for cohesive integration
Grouping of compatible classes to ensure harmonious execution
Adjustment of class formats and technical properties for optimal performance

3. optionally Template and Content Integration: 520A
Optional selection of video templates based on analyzed classes
Identification and incorporation of appropriate functional blocks
Selection of relevant scenario types and class-specific objects
Potential script modification or generation based on selected classes
Implementation of class-specific directing instructions
Integration of customized brand classes and their associated instructions

Optionally changing/generating script based on selected classes, like directing instruction form the classes or customized Classes of brands, classes including instructions

4. Multimedia Content Aggregation: 530
Comprehensive exploration and aggregation of content from diverse sources
Content types include text, images, and videos
Selection based on relevance to identified class requirements

5. Advanced Scene Creation: 540
Development of scenes using aggregated and class-aligned content
Generation of new, original content when necessary
Ensuring seamless integration with selected classes and templates

6. Sophisticated Audio Production: 550
Voiceover generation using cutting-edge Text-to-Speech (TTS) technology
Application of appropriate narrator tones (e.g., friendly, excited, cheerful)
Emotional expression tailoring for specific contexts (e.g., advertisements)
Selection of complementary background music to enhance overall impact

7. Intelligent Text Generation:
Automatic creation of text for all video placeholders
Ensuring consistency with class requirements and overall video style

8. Comprehensive Customization and Personalization:
Tailoring of all scene media components to align with entity branding
Adaptation for requesting entity (company or individual user)
Incorporation of branding and profile data through two methods:
   a. Direct input from the user
   b. Smart analysis of entity content (websites, logos, press materials)
Ensuring brand consistency across all video elements

Generating new video by implementing selected or new video template with the relevant classes aggregating content wherein the generated video complies with all analyzed requirements 560;

9. Quality Assurance and Optimization:
Continuous evaluation of class application effectiveness
Real-time adjustments to maintain optimal performance
Compatibility checks between different classes and content elements

10. Performance Analytics:
Implementation of tracking mechanisms to assess the impact of applied classes
Data collection on viewer engagement and response
Iterative improvement of class selection and application based on performance metrics

This elaborated process description provides a more detailed and nuanced understanding of how the system applies classes to video requirements. It emphasizes the intelligent, adaptive, and highly customized nature of the content creation process, highlighting the seamless integration of AI-driven decision-making with creative and technical elements.

Customization and Personalization: All scene media components are customized and personalized according to the branding and profile data of the requesting entity (company, human user). Branding elements can be provided directly by the user or derived through smart analysis of entity content such as websites, logos, or press media.

FIG. 5B is a flowchart depicting applying of Classes to Video Requirement o, according to some embodiments of the invention.

### Enhanced Class Selection and Integration System

### 1. Intelligent Class Selection (510B)

### AI-Driven Selection Process

The system employs advanced AI algorithms to identify and select the most appropriate classes for specific tasks:
Task-Specific Analysis: Evaluating requirements for diverse applications including:
   Product promotion campaigns
   Script support and enhancement
   Content adaptation and optimization
Multi-Criteria Evaluation: Classes are assessed based on:
   Relevance Score: How well the class aligns with task objectives
   Effectiveness Metrics: Historical performance data and success rates
   Compatibility Index: Technical and stylistic compatibility with project requirements
   Resource Optimization: Computational efficiency and implementation feasibility

### Selection Methodology 520B

Context Awareness: Understanding the broader project scope and target audience
Performance Prediction: Forecasting outcomes based on class characteristics
Dynamic Adaptation: Real-time adjustment of selection criteria based on project evolution

### 2. Advanced Class Combination and Adaptation (530B)

### Strategic Script Segmentation

Segment Analysis: Breaking down scripts into logical components for targeted class assignment
Contextual Mapping: Matching specific classes to corresponding script sections based on:
   Narrative flow requirements
   Visual style preferences
   Functional specifications
   Audience engagement objectives

### Comprehensive Style Integration 540B

Style Coherence Analysis: Examining visual and functional characteristics of each class
Adaptive Style Matching: Implementing intelligent style adaptation to ensure:
   Visual Consistency: Harmonized color schemes, typography, and layout patterns
   Functional Uniformity: Consistent interaction patterns and user experience
   Brand Alignment: Adherence to established brand guidelines and identity

According to some embodiments of the present invention it is suggested to identify requirement to generate new class using a designated AI model based on task and script wherein the creation of the new class is based on similar classes, changing features which don't appear and are required for the tasks. (Identifying classes based only on task not script.

1. A computer-implemented method for generating variant video using an AI model, implemented by one or more processors operatively coupled to a non-transitory computer readable storage device, on which are stored modules of instruction code that when executed cause the one or more processors to perform said method comprising the steps of:
performing predefined class definition analysis by:
analyzing style characteristics to identify visual and structural patterns unique to each predefined class;
classifying data fields according to their properties and types;
determining required input and output formats and data structures for each class;
performing functional context analysis predefined class, using an AI model by:
parsing and interpreting functional requirements and specifications;
analyzing object relationships and associated data dependencies;
generating a customized AI model that synthesizes the class definition analysis and functional context analysis; and
producing specialized video content using the customized AI model based on the predefined class definitions.

2. The method of claim 1, wherein the customized AI model employs tag-based learning by extracting knowledge from class tags and object classifications.

3. The method of claim 1, wherein the customized AI model employs structural learning by understanding relationships between class objects and their hierarchical organization.

4. The method of claim 1, wherein the customized AI model employs example-driven learning incorporating specific examples selected from the group consisting of:
class implementations;
object instances;
attribute configurations; and
behavioral patterns.

5. The method of claim 1, wherein analyzing style characteristics comprises identifying visual patterns and structural patterns that distinguish each class from other classes in the system.

6. The method of claim 1, wherein detecting issues within class definitions comprises identifying potential problems, constraints, or limitations that may affect class implementation or performance.

7. The method of claim 1, wherein identifying parsing and interpreting functional requirements and specifications comprises recognizing functional blocks and determining their interdependencies within the system architecture.

8. A system for generating customized video content using artificial intelligence, comprising:
a processor; and
a memory storing instructions that, when executed by the processor, cause the system to:
perform class definition analysis including style analysis, issue identification, field classification, and format specification determination;
perform functional context analysis using an AI model to comprehend instructions, identify functional blocks, map scenarios, analyze object relationships, and assess data relevance;
generate a customized AI model that synthesizes results from the class definition analysis and functional context analysis; and
produce specialized video content using the customized AI model based on predefined class definitions.

9. The system of claim 8, wherein the instructions further cause the system to implement multiple learning mechanisms including tag-based learning, structural learning, and example-driven learning.

10. The system of claim 8, wherein the functional context analysis comprises scenario mapping to understand various use cases and operational contexts for video content generation.

11. The method of claim 1, wherein the class definition analysis and functional context analysis are performed iteratively to refine the customized AI model based on feedback from video content generation results.

12. A computer-implemented method for generating variant video using an AI model, implemented by one or more processors operatively coupled to a non-transitory computer readable storage device, on which are stored modules of instruction code that when executed cause the one or more processors to perform said method comprising the steps of:
perform intelligent class selection by utilizing artificial intelligence model to select relevant classes for a given task from a plurality of predefined classes, wherein the task comprises at least one of product promotion and script support;
perform class combination and adaptation by strategically selecting classes for each segment of a script, analyzing styles of the selected classes, and grouping compatible classes with adjusted formats and technical properties for optimal performance;
aggregate multimedia content from diverse sources comprising text, images, and videos, wherein the content is selected based on relevance to requirements of the selected classes;
create scenes using the aggregated content aligned with the selected classes, including generation of new original content when necessary;
produce audio components comprising voiceover generation using text-to-speech technology with selectable narrator tones and complementary background music;
generate text for video placeholders ensuring consistency with class requirements and overall video style; and
customize all scene media components to align with entity branding by incorporating branding and profile data obtained through at least one of direct user input and automated analysis of entity content.

13. The method of claim 12, wherein the instructions further cause the system to:
implement performance analytics by establishing tracking mechanisms to assess impact of applied classes;
collect data on viewer engagement and response; and
perform iterative improvement of class selection and application based on performance metrics.

14. The method of claim 12, wherein the intelligent class selection comprises:
analyzing task requirements to determine effectiveness and compatibility metrics for available classes;
ranking classes based on relevance to project goals; and
selecting an optimal combination of classes that maximizes task performance while maintaining technical compatibility.

15. The method of claim 12, wherein the customization of scene media components comprises:
analyzing entity branding elements including logos, color schemes, and typography;
extracting branding data from entity websites and press materials using automated content analysis; and
applying the extracted branding elements consistently across all generated video components.

16. The method of claim 12, further comprising:
modifying the content script based on the selected classes; and
generating directing instructions derived from customized brand classes, wherein the classes include embedded instructions for content creation.

17. The method of claim 12, wherein the operations further comprise:
performing advanced scene creation by developing scenes using both aggregated content and newly generated original content when existing content is insufficient for class requirements.

18. The method of claim 12, wherein the audio production comprises:
analyzing contextual requirements of the video content to determine appropriate emotional expression;
selecting narrator tones from a plurality of available tones including friendly, excited, and cheerful tones;
tailoring emotional expression specifically for advertisement contexts; and
matching background music to enhance overall impact of the generated video content.
